(19) United States
(12) Patent Application Publication
(10) Pub. No.: US 2013/0067143 A1
(43) Pub. Date: Mar. 14, 2013

(54) MEMORY DEVICE AND METHOD OF CONTROLLING THE SAME

(71) Applicants: Misao HASEGAWA, Yokohama-shi (JP); Atsushi Shiraishi, Kawasaki-shi (JP)

(72) Inventors: Misao HASEGAWA, Yokohama-shi (JP); Atsushi Shiraishi, Kawasaki-shi (JP)

(21) Appl. No.: 13/427,055

(22) Filed: Mar. 22, 2012

(30) Foreign Application Priority Data
Sep. 13, 2011 (JP) 2011-199695

(51) Int. Cl. G06F 12/00

(52) U.S. Cl. 711/103; 711/E12.008

(57) ABSTRACT

According to one embodiment, a memory device includes a nonvolatile memory, a command storage module in which a command is stored, and a controller which receives the command from a host device, stores the command in the command storage module, executes the command stored in the command storage module, and after having completed the execution of the command, transmits, to the host device, a first signal reporting the completion of the execution of the command.

### CROSS-REFERENCE TO RELATED APPLICATIONS

This application is based upon and claims the benefit of priority from prior Japanese Patent Application No. 2011-199695, filed Sep. 13, 2011, the entire contents of which are incorporated herein by reference.

### FIELD

Embodiments described herein relate generally to a memory device and a method of controlling the same.

### BACKGROUND

There are various types of mediums that hold data. One of them is, for example, a universal flash storage (UFS) memory device. When a host device has issued an instruction to a UFS memory device, it encounters the problem of experiencing a longer waiting time to receive a response from the UFS memory device.

### BRIEF DESCRIPTION OF THE DRAWINGS

FIG. 1 shows a hardware configuration of a memory device according to a first embodiment;

FIG. 2 is a circuit diagram of a memory according to the first embodiment;

FIG. 3 shows a configuration of a memory space according to the first embodiment;

FIG. 4 shows a state where the memory device is sealed in the first embodiment;

FIG. 5 shows a functional block of the memory device according to the first embodiment;

FIG. 6 shows a packet according to the first embodiment;

FIG. 7 shows a conversion table for logical addresses and physical addresses in the first embodiment;

FIG. 8 is a detailed functional block diagram of a logical unit (LU) according to the first embodiment;

FIG. 9 is a detailed block diagram of a queue area according to the first embodiment;

FIG. 10 is a flowchart to roughly explain a command abort method according to the first embodiment;

FIG. 11 shows an example of communication between the memory device and host device according to the first embodiment;

FIG. 12 shows an example of communication between a memory device and a host device according to a second embodiment; and

FIG. 13 shows communication between a memory device and a host device in a comparative example.

### DETAILED DESCRIPTION

In general, according to one embodiment, a memory device comprises a nonvolatile memory, a command storage module in which a command is stored, and a controller which receives the command from a host device, stores the command in the command storage module, executes the command stored in the command storage module, and after having completed the execution of the command, transmits, to the host device, a first signal reporting the completion of the execution of the command. In the memory device, the command includes at least either a first command or a second command. In addition, the controller causes the memory to be written to, read from, or erased from in response to the first command, aborts the first command in the command storage module or the first command being executed in response to the second command, aborts an interruptible one of the first commands to be aborted on having executed the second command, and transmits the first signal about the second command after having transmitted the first signal about all the ones not aborted of the first commands to be aborted.

Hereinafter, referring to the accompanying drawings, embodiments will be explained. In an explanation below, structural elements that have almost the same functions and configurations are indicated by the same reference numerals. Each embodiment described below illustrates an apparatus or a method for embodying the technical idea of the embodiment. The technical idea of the embodiment does not limit the materials, shapes, structures, arrangements, and others of component parts to those described below. The technical idea of the embodiment may be modified variously within the scope of the accompanying claims.

### First Embodiment

### Overview of Memory Device

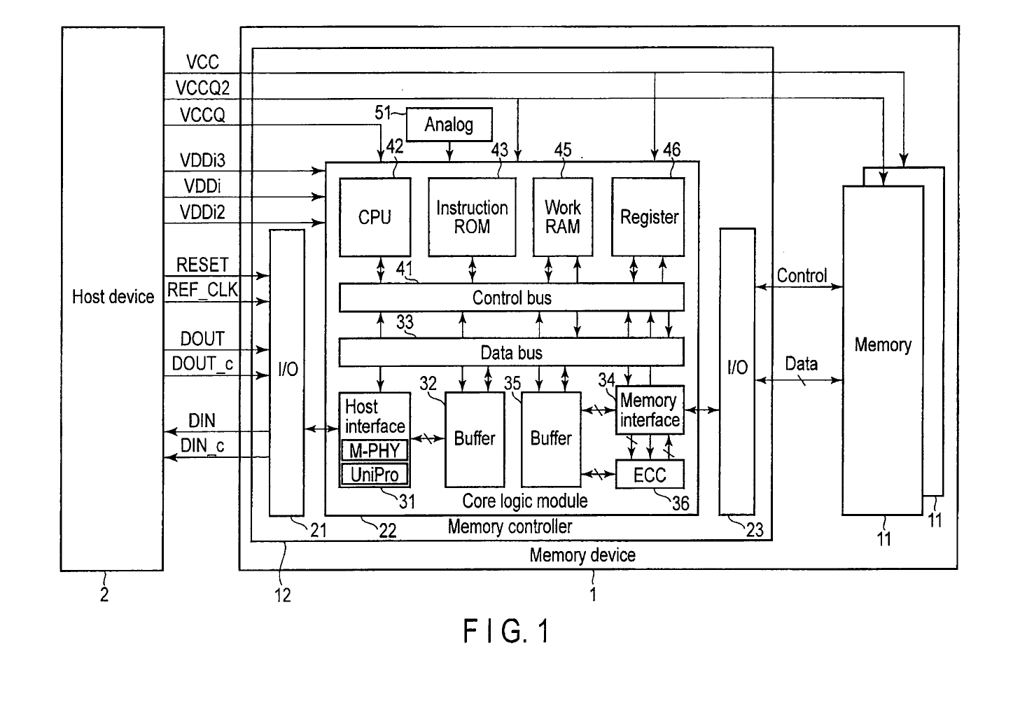

FIG. 1 schematically shows a memory device according to a first embodiment. FIG. 1 shows a hardware configuration of the memory device.

As shown in FIG. 1, the memory device (semiconductor memory device) 1 is configured to be capable of communicating with a host device (hereinafter, sometimes simply referred to as a host) 2. The memory device 1 functions as a target and the host device 2 functions as an initiator. Specifically, for example, the memory device 1 is a UFS memory device and the host device 2 is a host that supports the UFS memory device.

The memory device 1 comprises at least a nonvolatile semiconductor memory 11 and a memory controller 12 for controlling the memory 11. The memory 11 writes and reads data in specific write units of a plurality of bits. In addition, the memory 11 erases data in erase units of a plurality of write units.

The memory device 1 further comprises an I/O 21, a core logic module 22, and an I/O 23. The I/O 21 includes a hardware configuration that connects the memory device 1 with the host device 2. When the memory device 1 is a UFS memory device, the signals exchanged between the memory device 1 and host device 2 include RESET, REF_CLK, DOUT, DOUT_c, DIN, DIN_c, VCC, VCCQ, VCCQ2, VDDi, VDDi2, and VDDi3. RESET, REF_CLK, DOUT, DOUT_c, DIN, and DIN_c are exchanged between the host device 2 and I/O 21. RESET is a hardware reset signal. REF_CLK is a reference clock. DOUT and DOUT_c form a differential signal pair and are transmitted from the host device 2 to the memory device 1. DIN and DIN_c form a differential signal pair and are transmitted from the memory device 1 to the host device 2. VCC, VCCQ, and VCCQ2 are power supply voltages supplied to the memory 11 and core logic module 22. VDDi, VDDi2, and VDDi3 are supplied to the core logic module 22. They are input when a voltage regulator is provided in the core logic module 22.

The core logic module 22 is the main part of the memory controller 12 excluding the I/Os. The I/O 23 includes a hardware configuration for connecting the memory controller 12 with the memory 11. The core logic module 22 comprises a host interface 31, a buffer 32, a data bus 33, a memory interface 34, a buffer 35, an ECC circuit 36, a control bus 41, a central processing unit (CPU) 42, a read-only memory (ROM) 43, a random-access memory (work RAM) 45, and a register 46.

The I/O 21 is connected with the host interface 31. The host interface 31 performs a process necessary for communication between the memory device 1 and host device 2. Specifically, the host interface 31 supervises communication between the memory device 1 and host device 2 according to a communication protocol to which both the memory device 1 and host device 2 conform. When the memory device 1 is a UFS memory device, for example, the host interface 31 is a USF interface. The UFS interface complies with the M-PHY standard in terms of a physical layer and with the UniPro standard in terms of a link layer.

The host interface 31 is connected to the buffer 32. The buffer 32 receives, via the host interface 31, data transmitted from the host device 2 to the memory device 1 and holds the data temporarily. The buffer 32 further temporarily holds data transmitted from the memory device 1 to the host device 2 via the host interface 31. The buffer 32 is connected to the data bus 33.

The I/O 23 is connected to the memory interface 34. The memory interface 34 performs a process necessary for communication between the memory controller 12 and the memory 11. Specifically, the memory interface 34 transmits an instruction from the core logic module 22 in the form the memory 11 can recognize. When the memory 11 is a NAND flash memory, the memory interface 34 is a NAND flash interface. The memory 11 is not limited to a NAND flash memory and may be any type of memory, provided that it is a nonvolatile memory.

The memory interface 34 is connected to the buffer 35. The buffer 35 receives, via the memory interface 34, data transmitted from the memory 11 to the memory controller 12 and holds the data temporarily. The buffer 35 further temporarily holds data to be transmitted from the memory controller 12 to the memory 11 via the memory interface 34. The buffer 35 is connected to the data bus 33. The memory interface 34 and buffer 35 are connected to the error correcting code (ECC) circuit 36. The ECC circuit 36 is also connected to the data buffer 35. The ECC circuit 36 receives write data from the host device 2 via the data bus 33, adds error correction code to the write data, and supplies the error-correction-code-added write data to the buffer 35. The ECC circuit 36 further receives, via the buffer 35, data supplied from the memory 11, corrects errors in the data using the error correcting code, and supplies the error-corrected data to the data bus 33.

Connected to the control bus 41 are the CPU 42, ROM 43, RAM 45, and register 46. The CPU 42, ROM 43, RAM 45, and register 46 communicate with one another via the control bus 41. The CPU 42 supervises the overall operation of the memory device 1. The CPU 42 executes a specific process according to a control program (instructions) stored in the ROM 43. The CPU 42 performs a specific process on the memory 11 according to a command received from the host device 2 according to the control program.

The ROM 43 stores a control program or the like executed by the CPU 42. The RAM 45 is used as a work area of the CPU 42 and temporarily stores variables and the like necessary for the work of the CPU 42. The register 46 holds various values necessary for the operation of the memory device 1. The register 46 further holds various values necessary for the host device 2 to control the memory device 1.

Connected to the control bus 41 are the host interface 31, buffer 32, memory interface 34, and buffer 35. On the basis of the control program or an instruction from the host device 2, the CPU 42 controls the host interface 31, buffer 32, memory interface 34, and buffer 35. The memory controller 12 may be provided with an analog circuit 51.

<Overview of Memory>

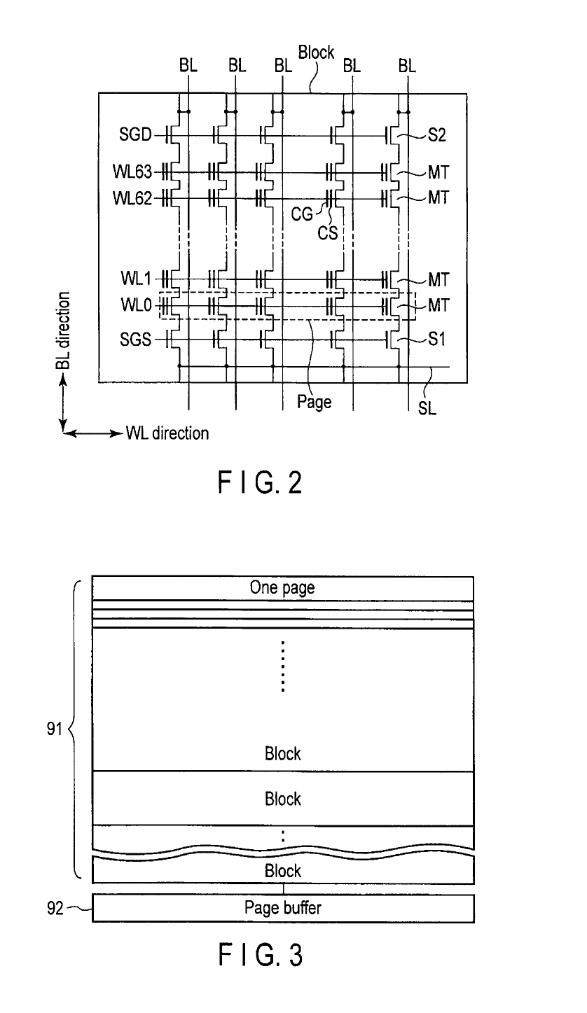

For example, the memory 11 includes one or more NAND flash memories. When the memory 11 is a NAND flash memory, the memory 11 writes and reads data in pages. As shown in FIG. 2, a page is composed of a memory space of a set of a plurality of memory cell transistors. A unique physical address is allocated to a page. Each of the memory cell transistors (also referred to as memory cells or cell transistors) MT is a metal oxide semiconductor field-effect transistor (MOSFET) with a so-called stacked gate structure. In each memory cell transistor MT, its threshold voltage varies according to the number of electrons stored in a charge storage layer CS. The memory cell transistor MT memorizes information according to the difference in the threshold voltage. The current paths (source/drain SD) of memory cell transistors MT are connected in series, thereby forming a NAND string. Select transistor S1 is connected to one end of the NAND string and select transistor S2 is connected to the other end of the NAND string. The other end of the current path of select transistor S2 is connected to a bit line BL and the other end of the current path of select transistor S1 is connected to a source line SL.

Word lines WL0 to WL63 extend in a WL direction and are connected to the control gates CG of the memory cell transistors MT belonging to the same row. The memory cell transistors MT are provided at the intersections of bit lines BL and word lines WL in a one-to-one correspondence. A select gate line SGD extends in the WL direction and is connected to all the select transistors S2 in a block. A select gate line SGS extends in the WL direction and is connected to all the select transistors S1 in a block. A plurality of memory cell transistors connected to the same word line WL constitute a page.

As shown in FIG. 3, the memory 11 comprises a memory cell array 91 that includes a plurality of memory cell transistors and a page buffer 92 that inputs data from and outputs data to the memory cell transistors. The page buffer 92 holds one page of data. When writing data to the memory 11, the memory controller 12 transmits, to the memory 11, a write commend together with a page address that indicates a write destination and one page of write data. The memory 11 stores the write data received from the memory controller 12 in the page buffer 92 and writes the write data in the page buffer 92 to the memory cells specified by the page address. On having started to write data to the memory cells, the memory 11 outputs a busy signal indicating “in operation” to the memory controller 12. When continuing to write data, the memory 11 performs the same operation at the next page address after the busy signal has been switched to a ready signal.

When reading data from the memory 11, the memory controller 12 transmits, to the memory 11, a read command together with a page address indicating a read destination. The memory 11 reads one page of data from the memory cells specified by the page address into the page buffer 92. On having started to read data from the memory cells, the memory 11 outputs a busy signal to the memory controller 12. Then, after the busy signal has been switched to a ready signal, the memory 11 outputs the data read into the page buffer 92 to the memory controller 12. When continuing to read data, the memory 11 performs the same operation at the next page address.

When the memory 11 is a NAND flash memory, a memory cell transistor MT may take two or more states differing in threshold voltage. That is, the memory 11 may be so configured that one memory cell can store multiple levels (multiple bits). In the case of a memory capable of storing multiple levels, a plurality of pages are allocated to one word line.

In addition, when the memory 11 is a NAND flash memory, the memory 11 erases data in blocks. Each block is composed of a plurality of pages that have consecutive physical addresses. In the explanation below, let a write unit be a page and an erase unit be a block for the sake of convenience. However, the memory 11 is not necessarily limited to a NAND flash memory.

<Package of Memory>

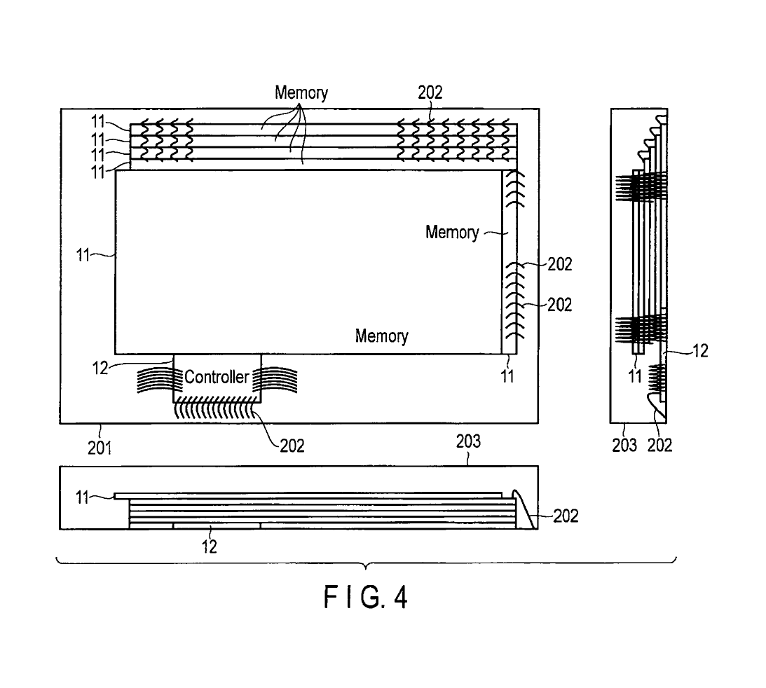

The memory device 1 may be, for example, of the embedded type where the memory device is solder-mounted on a printed circuit board or of the removable type where the memory device can be inserted in and removed from a card slot made in the host device 2. FIG. 4 shows an example of the memory device 1 in a sealed state. As shown in FIG. 4, a plurality of chip-like memories 11 are stacked one on top of another on a printed circuit board 201. Each memory 11 is connected to an interconnection pattern (not shown) on the printed circuit board 201 with wires 202. A chip-like memory controller 12 is also placed on the printed circuit board 201 and connected to the interconnection pattern with wires 202. On the underside of the printed circuit board 201, external terminals (not shown) (e.g., a ball grid array [BGA]) are provided. Allocated to the external terminals are RESET, REF_CLK, DOUT, DOUT_c, DIN, DIN_c, VCC, VCCQ, VCCQ2, VDDi, VDDi2, and VDDi3 shown in FIG. 1. The memory device 1 exchanges signals with the host device 2 outside the memory device 1 via the external terminals. The printed circuit board 201, memories 11, memory controller 12, and wires 202 are sealed with, for example, a resinous package 203.

<Functional Configuration of Memory Device>

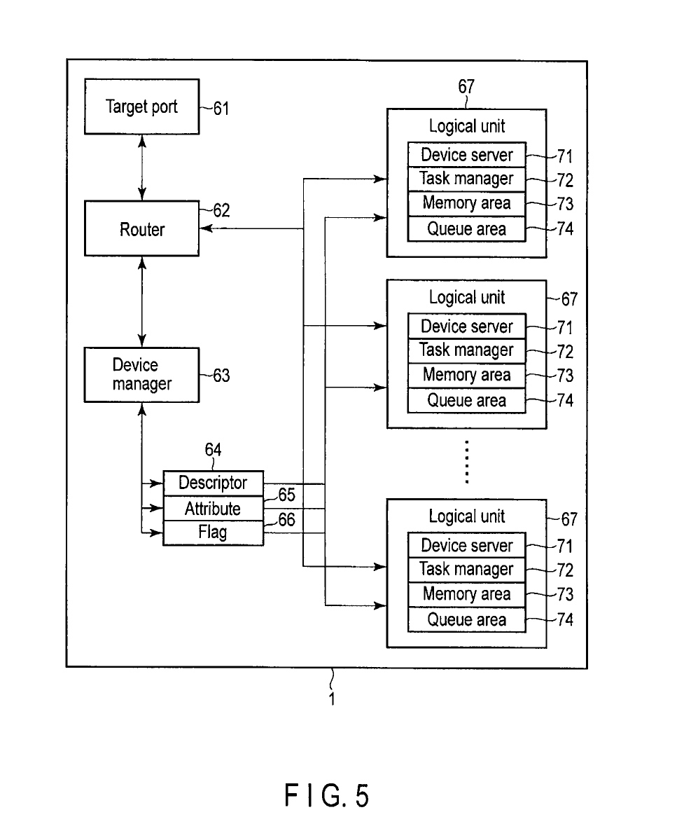

Next, FIG. 5 shows a configuration of the memory device 1 from another viewpoint. Specifically, FIG. 5 shows a logical configuration of the memory device 1, that is, a functional block of the memory device 1. Each block can be realized by either hardware or computer software or by a combination of them. Whether each functional block is implemented in hardware or software depends on design constraints imposed on a specific embodiment or the entire system. Those skilled in the art can realize those functions by various methods for each specific embodiment. Any method of realizing the functions falls within the scope of the embodiment. Distinguishing the functional blocks as shown in concrete examples described below is not indispensable. For example, a part of the functions may be implemented by a functional block differing from the ones illustrated in the explanation below. In addition, the illustrated blocks may be further divided into functional sub-blocks. An embodiment is not limited, depending on which blocks constitute the embodiment.

The memory device 1 comprises a target port 61, a router 62, a device manager 63, a descriptor 64, an attribute 65, a flag 66, and a plurality of logical units (LUs) 67. The target port 61 is for connecting the memory device 1 with the host device 2 to enable communication between them. The target port 61 corresponds to, for example, the host interface 31. The router 62 routes communication (task, command, data, query, and the like) received from the host device 2 to the logical unit 67 at the destination. The host device 2 requests the processing of a command or a task management function through a request addressed to one logical unit 67. The logical units 67 are identified by their addresses (e.g., logical unit numbers [LUNs]). Hereinafter, suppose commands include LU commands (write commands, read commands, or the like), tasks, and queries.

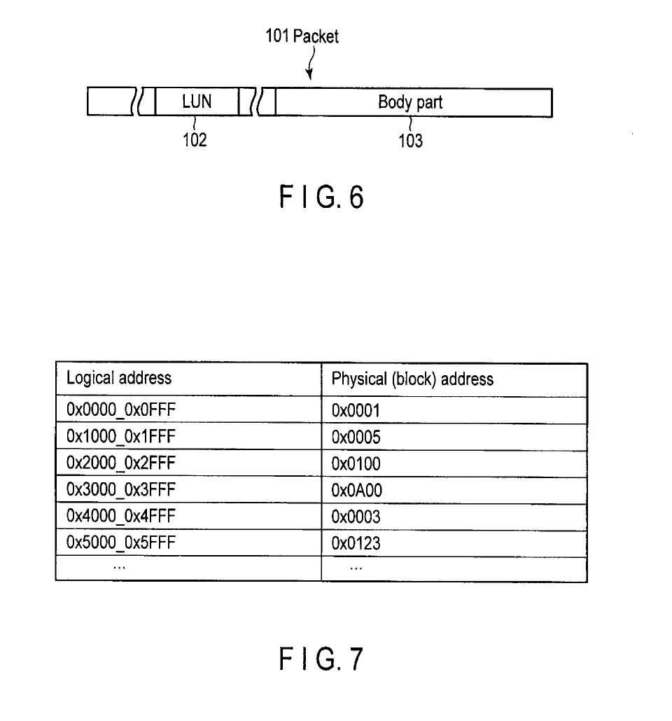

For example, as shown in FIG. 6, LUN can be included in (packet) communication between the memory device 1 and host device 2 in the UFS memory device. A packet 101 includes a LUN 102 and a body part 103.

The LUN 102 can be included in, for example, the header of a packet 101. A logical unit 67 at the destination of each packet is determined uniquely by a LUN.

The body part 103 includes contents unique to the function of the packet, for example, a task, data, an LU command, a query, various parameters, and the like. Specifically, the body part 103 of the packet includes a command description part. In the command description part, a Small Computer System Interface (SCSI) command is stored. The SCSI command includes a specific command, an address, and other items.

As shown in FIG. 5, the router 62 routes communication (including the task, LU command, data, and query) received from the host device 2 to the logical unit 67 at the destination on the basis of the LUN during communication. In addition, the router 62 transmits communication from a plurality of logical units 67 to the host device 2 in a suitable sequence in a time-division manner to the target port 61. The router 62 is realized by, for example, the CPU 42, ROM 43, and register 46. That is, the router 42 is realized by the CPU 42 executing a program in the ROM 43 referring to values in the register 46.

The device manager 63 manages device-level operations and configurations. The management of device levels includes, for example, the power management of the memory device 1 and control including sleep. The device-level configuration includes holding a group of descriptors. The device manager 63 processes such a command as a query request, a change and output request from the host device 2 for the change and output of configuration information on the memory device 1. The device manager 63 is realized by, for example, the CPU 42, ROM 43, and register 46. That is, the device manager 63 is realized by the CPU 42 executing a program in the ROM 43 referring to values in the register 46.

The descriptor 64, attribute 65, and flag 66 are realized in the form of data in, for example, the work RAM 45 and register 46. The descriptor 64 has a data structure in a previously defined format and is for describing some characteristics of the memory device 1. The descriptor 64 includes, for example, a device class, a sub-class, a protocol, and the like necessary to access the memory device 1. The attribute 65 is changeable or read-only parameters set for the memory device 1. The attribute 65 includes, for example, the maximum value of data transferable between the memory device 1 and host device 2. The flag 66 is composed of an alternative logical value for each of various items and represented as, for example, true or false or as 0 or 1.

<Configuration of Logical Unit>

Each logical unit 67 is realized by, for example, the memory 11, memory interface 34, buffer 35, ECC circuit 36, CPU 42, ROM 43, and register 46 (see FIG. 1). The logical units 67 perform processes from the host device 2 independently of one another. Therefore, each logical unit 67 is realized by using a part of the resources that include the memory 11, interfaces 21, 23, buffer 35, ECC circuit 36, CPU 42, ROM 43, and register 46. The individual logical units are distinguished from one another by the host device 2 using LUNs that identify the individual logical units. A command from the host device 2 is executed by a specified logical unit 67.

Each of the logical units 67 comprises a device server 71, a task manager 72, a memory area 73, and a queue area 74.

The queue area 74, which is realized by such hardware as the work RAM 45 or register 46, holds tasks, LU commands, queries, and the like from the host device 2.

The memory area 73 is composed of a part of the memory area of the memory 11 and stores write data from, for example, the host device 2.

The device manager 71 and task manager 73 are realized by, for example, the CPU 42, ROM 43, and register 46. That is, the device manager 71 and task manger 73 are realized by the CPU 42 executing a program in the ROM 43 referring to values in the register 46.

The device server 71 interprets a command requesting an LU-level process received from the host device 2. Specifically, the device server 71 determines whether the command is a task, an LU command, or a query and allocates them to specific areas in the queue area 74. In addition, the device server 71 executes a task, an LU command, or a query. Such a process includes, for example, writing data, reading data, and erasing data.

Since a logical unit 67 includes a memory area 73, the device server 71 has at least the function of controlling the memory area 73 (memory 11).

The task manager 72 controls the sequence of executing a plurality of commands, thereby providing a task management function. For example, the task manager 72 controls the sequence of executing the tasks, LU commands, or queries held in the queue area 74.

As described above, the device server 71 performs a process related to control of the memory 11. Such a process includes the conversion of logical addresses to physical addresses or vice versa. A logical address is allocated by the host device 2 to data the host device 2 is to write to the memory device 1. As described above, a physical address is used to determine a write area (page) or an erase area (block) of the memory 11. The device server 71 manages the state where the memory area 73 corresponding to the device server 71 stores data. The management of the storage state includes managing the relationship between a page (or a physical block) at a physical address and data at a logical address the page holds and the erased state of a page (or a physical block) at a physical address (or the state where nothing has been written or invalid data has been held in a page at a physical address). For the management, the device server 71 holds, for example, a logical address/physical address conversion table (hereinafter, sometimes simply referred to as a conversion table).

As an example of conversion, for example, logical addresses can be allocated in blocks as shown in FIG. 7. A fixed logical address offset is allocated to each page in each block. FIG. 7 shows a case where the size of a write unit of the memory 11 is 16 KB and logical addresses are allocated in units of 512 bytes of data.

<Configuration of Device Server>

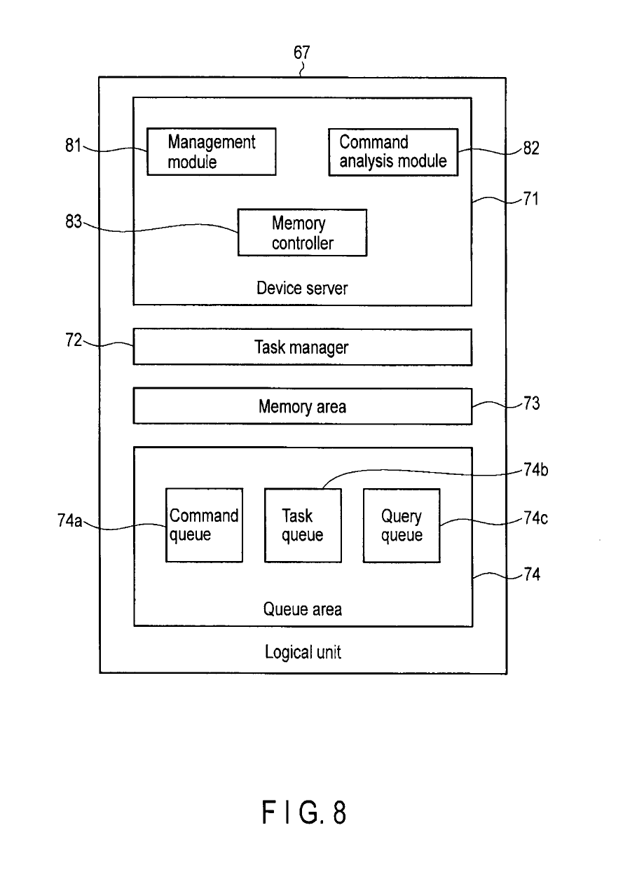

Next, the device server 71 will be explained in further detail with reference to FIG. 8. At least one of, typically any of, the logical units 67 has a configuration shown in FIG. 8.

As shown in FIG. 8, the device server 71 comprises a management module 81, a command analysis module 82, and a memory controller 83.

The management module 81 manages the whole of the device server 71. The command analysis module 82 receives a command from the host device 2 via the router 62. The command analysis module 82 also analyzes the received command. In addition, on having received a command, the command analysis module 82 allocates the command to the queue area 74. The memory controller 83 issues any instruction to the memory 11 according to an instruction from the management module 81.

<Configuration of Queue Area>

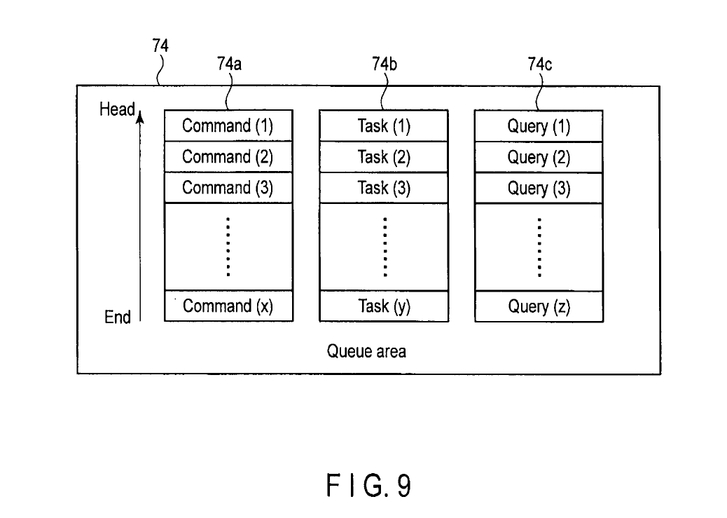

Next, the queue area 74 will be explained with reference to FIGS. 8 and 9. FIG. 9 schematically shows a basic configuration of the queue area 74 according to the first embodiment.

As shown in FIG. 8, the queue area 74 includes a command queue 74a that holds an LU command, a task queue 74b that holds a task, and a query queue 74c that holds a query.

Each of the command queue 74a, task queue 74b, and query queue 74c (these may be simply referred to as queues or queue spaces) is one of the data structures that temporarily hold data input and output repeatedly. A queue according to the first embodiment has such a structure as processes data in the order in which data has been input earlier. This method may be called a first-in, first-out (FIFO) method. Adding (or storing) data at the end of a queue is called queuing. Taking out data from the head of a queue is called dequeuing.

In the command queue 74a, data items (LU commands) are queued one by one in sequence, starting with Command (1) at the beginning down to Command (x) (x being an arbitrary integer greater than or equal to one) at the end. Then, data items (LU commands) are dequeued one by one in sequence, starting with Command (1) at the beginning.

In the task queue 74b, data items (tasks) are queued one by one in sequence, starting with Task (1) at the beginning down to Task (y) (y being an arbitrary integer equal to or larger than one) at the end. Then, data items (tasks) are dequeued one by one in sequence, starting with Task (1) at the beginning.

In the query queue 74c, data items (queries) are queued one by one in sequence, starting with Query (1) at the beginning down to Query (z) (z being an arbitrary integer equal to or larger than one) at the end. Then, data items (queries) are dequeued one by one in sequence, starting with Query (1) at the beginning.

In the memory device 1 of the first embodiment, a plurality of commands cannot be executed at the same time. That is, data will not be dequeued simultaneously from the command queue 74a, task queue 74b, and query queue 74c. Although the order in which data is dequeued has been determined in each queue, which of the command queue 74a, task queue 74b, and query queue 74c is dequeued preferentially can be determined suitably by, for example, the task manager 72. In the first embodiment, for example, the task manager 72 has performed setting so that the execution of the task queue 74b or query queue 74c may be given priority over that of the command queue 74a.

<Command Abort Method>

The host device 2 may issue, to the memory device 1, a command to abort all the commands stored in the queue area 74.

When each command has completed its process, the device server (specifically, for example, the management module 81) of the corresponding logical unit 67 transmits, to the host device 2, a response to the effect that the process associated with each command has been completed. As a result, the host device 2 recognizes that the process of each command has been completed.

However, for example, when each command has been aborted by an abort command, each aborted command does not transmit, to the host device 2, a response to the effect that the command has been aborted. On having received a response to the effect that the abort command has completed the abort process, the host device 2 recognizes that the abort command has been completed.

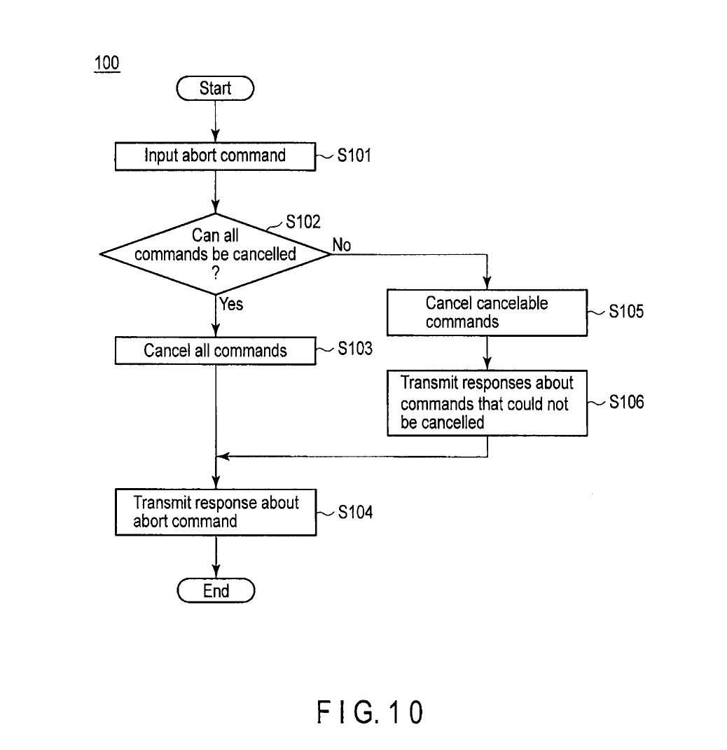

A command abort method 100 according to the first embodiment will be explained with reference to FIG. 10. FIG. 10 is a flowchart to roughly explain a command abort method according to the first embodiment. As an example, an explanation will be given about a case where an LU command stored in the command queue 74a (Command (1) to Command (x)) is aborted.

[Step S101]

The host device 2 inputs, to the memory device 1, an abort command (e.g., a task) to abort a command stored in at least the command queue 74a. The abort command (task) is input to the device server (specifically, for example, the command analysis module 82) of the logical unit 67. The command analysis module 82 queues the abort command in the task queue 74b. Since the task queue 74b is given priority over the command queue 74a, the abort command is dequeued before the command in the command queue 74a is dequeued.

[Step S102]

After the abort command has been dequeued, the management module 81 checks whether all the commands in the command queue 74a can be aborted, whether there is any command being executed, and whether the command being executed can be aborted.

[Step S103]

If the management module 81 can abort all the commands in the command queue 74a and the command being executed, it executes the abort command to abort all the commands.

[Step S104]

After the abort process has been completed, the management module 81 of the corresponding logical unit 67 transmits, to the host device 2, a response to the effect that the abort has been completed. There are two types of response to the effect that the abort has been completed: “All commands successfully aborted” and “Abort of commands complete, though not all commands aborted.” Therefore, for example, when the abort of all the commands has succeeded, the management module 81 may transmit, to the host device 2, a response to the effect that the abort has succeeded.

[Step S105]

In step S102, if the management module 81 has determined that there are commands that cannot be aborted (including a command being executed), it executes the abort command to abort only commands that can be aborted.

[Step S106]

After the abort process has been completed, the management module 81 transmits, to the host device 2, responses about all the commands that could not be aborted. After that, the management module 108 executes step S104.

<Concrete Example of the Command Abort Method According to the First Embodiment>

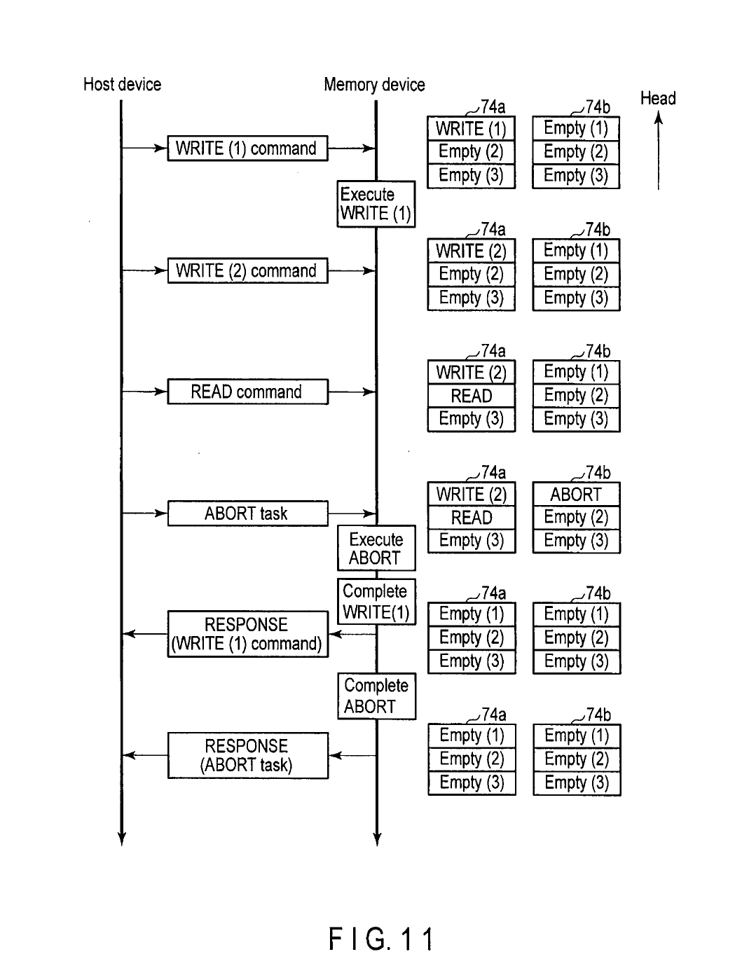

Next, communication between the host device 2 and memory device 1 when an LU command is aborted in the first embodiment will be explained with reference to FIG. 11. FIG. 11 shows communication between the host device 2 and memory device 1 and the operations of the command queue 74a and task queue 74b during the communication when an LU command input from the host device 2 to the memory device 1 is aborted by a task input from the host device 2 to the memory device 1. For the sake of simplicity, FIG. 11 shows the first three queues in each of the command queue 74a and task queue 74b. In addition, for simplicity, suppose nothing has been queued in the command queue 74a and task queue 74b in the beginning. Each communication corresponds to (packet) communication between the one logical unit 67 and the host 2.

As shown in FIG. 11, first, a first command (WRITE(1): a write command) is supplied from the host device 2 to the command analysis module 82 of the memory device 1. The command analysis module 82 determines that the command is an LU command (WRITE(1) command) and queues the LU command in the command queue 74a. At this time, since nothing has been queued in the command queue 74a, the LU command is queued at the head of the command queue 74a. Then, the WRITE(1) command queued at the head is dequeued, thereby performing a write operation in the memory area 73. The command queue 74a has become empty again.

As an example of the write operation, for example, before performing a write operation, the management module 81 returns, to the host device 2, a response to the effect that a preparation for writing has been made. Having received the response, the host device 2 transfers write data to the memory device 1. Having received the data, the device server 71 writes the data to the memory area 73.

Then, the host device 2 supplies a second command (WRITE(2): write command) to the command analysis module 82 of the memory device 1. The command analysis module 82 determines that the command is an LU command (WRITE(2) command) and queues the LU command (WRITE(2) command) in the command queue 74a. At this time, since nothing has been queued in the command queue 74a, the LU command has been queued at the head of the command queue 74a.

Then, the host device 2 supplies a third command (READ: read command) to the command analysis module 82 of the memory device 1. The command analysis module 82 determines that the command is an LU command (READ command) and queues the LU command (READ command) in the command queue 74a. At this time, the LU command (READ command) has been queued next to the WRITE(2) command.

Next, the host device 2 supplies a fourth command (ABORT: abort task) to the command analysis module 82 of the memory device 1. The command analysis module 82 determines that the command is a task (ABORT task) and queues the task (ABORT task) in the task queue 74b. At this time, the task (ABORT task) is queued at the head of the task queue 74b. The ABORT task is a command to abort all the commands stored in the queue area 74.

The task manager 72 has performed setting so that the task queue 74b may be given priority over the command queue 74a. Therefore, the management module 81 executes the ABORT task in preference to the WRITE(2) command. Because of the execution of the ABORT task, the WRITE(2) and READ commands stored in the command queue 74a are aborted. However, since the WRITE(1) command has already been executed, it is not aborted by the ABORT task. Even when a command is being executed, if the management module 81 has determined that the command can be aborted, it may be aborted.

When the command that can be aborted has been aborted, the management module 81 returns, to the host device 2, a response to the effect that the abort has been completed (a response about the ABORT task). When a command is being aborted, a command already executed or a command determined by, for example, the management module 81 not to be aborted might remain. In such a case, the management module 81 transmits, to the host device 2, a response about a command that could not be aborted and then transmits, to the host device 2, a response about the ABORT task. Therefore, as shown in FIG. 11, while the WRITE(1) command is being executed, the management module 81 does not transmit a response about the ABORT task to the host device 2.

Then, when the WRITE(1) command has been completed, the management module 81 transmits, to the host device 2, a response (RESPONSE (WRITE(1) command)) reporting the completion of the WRITE(1) command.

When the command that can be aborted has been aborted and a response about the command not aborted has been issued to the host device 2, the management module 81 transmits, to the host device 2, a response (RESPONSE (ABORT task)) to the effect that all the command aborts have been completed.

<Operational Advantages of the Memory Device of the First Embodiment>

With the first embodiment, the memory device 1 comprises a nonvolatile memory (memory area) 73, a command storage module (queue area) 74 in which a command is stored, and a controller (server device) 71 which receives a command from the host device 2, not only stores the command in the command storage module 74 but also executes the command, and after having executed the command, transmits, to the host device 2, a first signal (response) reporting the completion of the execution of the command. The controller 71 further writes data to, reads data from, or erases data from the memory 73 in response to a first command, and aborts the first command in the command storage module 74 or the first command being executed in response to a second command. In addition, the controller 71, on having executed the second command, not only aborts an interruptible one of the first commands to be aborted (the command stored in the command storage module 74 and a command being executed) but also transmits, to the host device 2, a first notice about those not aborted of the first commands to be aborted and then a first notice about the second command.

As described above, the memory device 1 controls the timing of transmitting a response to the host device 2, thereby enabling the host device 2 to recognize the state of the memory device 1 accurately. Hereinafter, more detailed effects of the first embodiment will be explained with reference to a comparative example.

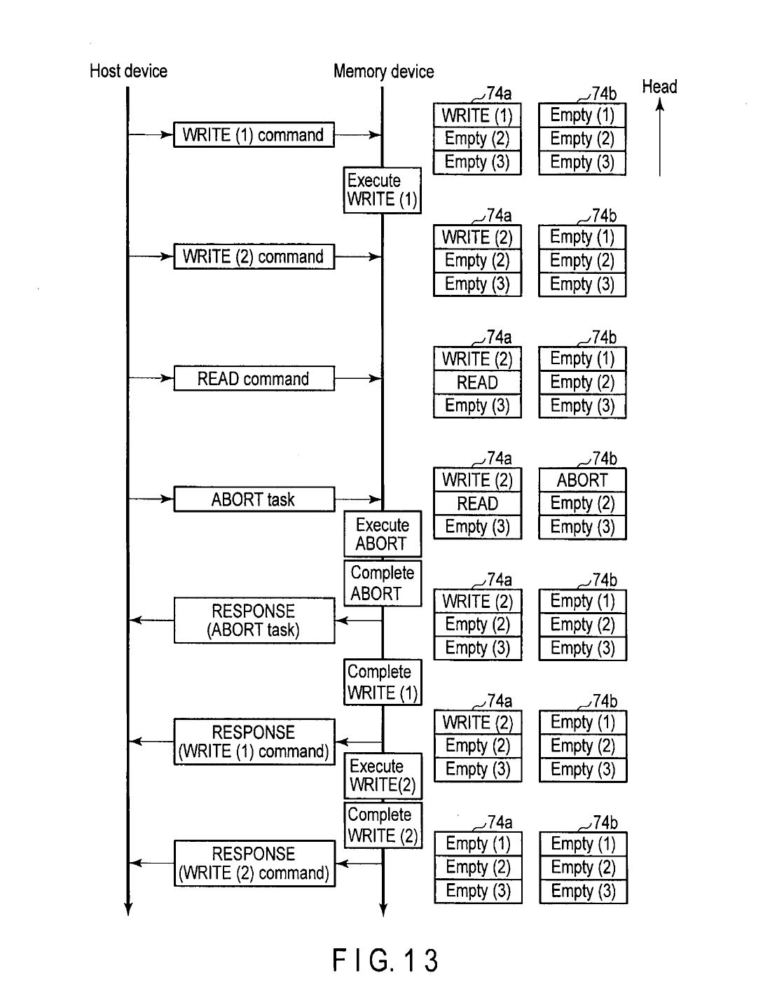

First, a comparative example will be roughly explained with reference to FIG. 13. The comparative example relates to a case where a response about the abort of a command is returned to the host device 2 before a command not aborted returns a response to the host device 2 at the time of the abort of a command.

As shown in FIG. 13, the same operation as explained in the first embodiment (FIG. 11) is performed until a task (ABORT task) is queued in the task queue 74b.

The task manager 72 performs setting so that the task queue 74b may be given priority over the command queue 74a. Therefore, the ABORT task is executed in preference to the WRITE(2) command. However, when the management module 81 has determined that the WRITE(2) command should not be aborted, the execution of the ABORT task causes the READ command stored in the command queue 74a to be aborted. However, before responses about the WRITE(1) and WRITE(2) commands are transmitted to the host device 2, the management module 81 transmits, to the host device 2, a response reporting that the abort of the command has been completed.

Thereafter, when the WRITE(1) command has been completed, the management module 81 transmits, to the host device 2, a response reporting the completion of the WRITE(1) command.

Then, the WRITE(2) command stored at the head is dequeued and written to the memory area 73. When the WRITE(2) command has been completed, the management module 81 transmits, to the host device 2, a response (RESPONSE (WRITE(2) command)) reporting the completion of the WRITE(2) command.

As described above, when each command has been aborted, the management module 81 does not transmit a response about the aborted command to the host device 2. Therefore, the host device 2 cannot clearly recognize which command has been aborted and which command has not been aborted. As a result, the host device 2 waits until responses from all the commands have been transmitted.

In the comparative example, although there is a command not aborted, a response to the effect that the abort of the command has been completed is transmitted to the host device 2. Therefore, the host device 2 cannot clearly recognize which command has been aborted and which command has not been aborted. As a result, the host device 2 confronts the problem of waiting for a specific time to receive a response from a command not aborted.

As described above, in the first embodiment, to overcome this problem, the sequence of responses is determined clearly so that the management module 81 may transmit responses about all the commands not aborted to the host device 2 and then transmit, to the host device 2, a response to the effect that the abort of commands has been completed. This enables the host device 2 to recognize that all the commands in the memory device 1 have been aborted or completed on having recognized a response to the effect that the abort of commands has been completed. Use of the memory device 1 like this enables the host device 2 to proceed to a desired process with no waiting time on having recognized a response to the effect that the abort of commands has been completed. For example, communication between the memory device 1 and host device 2 is performed smoothly.

As explained in step S104, there are two types of responses to the effect that abort has been completed. Therefore, when there is only one command to be aborted, the host device 2 recognizes whether the command has been aborted merely by receiving two types of responses to the effect that abort has been completed. Therefore, on having received a response reporting that “Although not all commands successfully aborted, command abort process is complete,” the host device 2 can recognize that the command has not been aborted. The host device 2 has only to wait for a response from the command. However, as described above, when there are a plurality of commands to be aborted, the host device cannot recognize clearly which one of the commands to be aborted has been aborted and not have been aborted merely by having received a response reporting that “Although not all commands successfully aborted, command abort process is complete.” As described above, when there are a plurality of commands to be aborted, the first embodiment is particularly effective.

### Second Embodiment

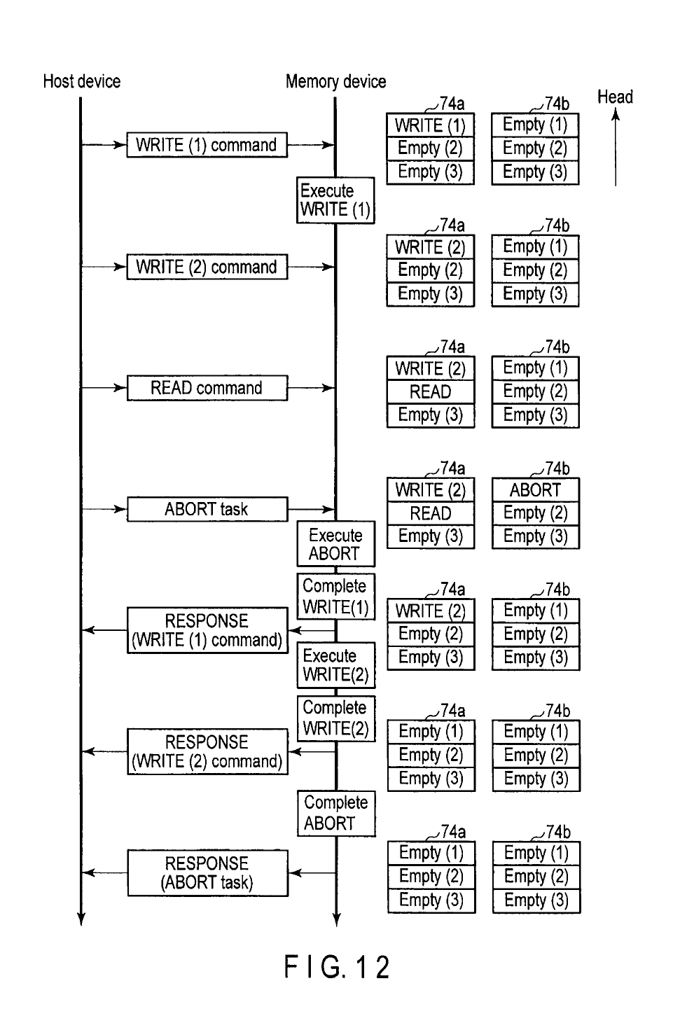

Next, a second embodiment will be explained with reference to FIG. 12. A memory device according to the second embodiment has the same hardware configuration and functional blocks as those of the first embodiment. As for what has not been touched on in the explanation of the second embodiment, it should be noted that all the description of the first embodiment is applied to the second embodiment. The second embodiment is related to a case where a command being executed and a command not aborted remain in a queue when a command is aborted.

<Concrete Example of a Method of Aborting a Command According to the Second Embodiment>

FIG. 12 shows communication between the host device 2 and memory device 1 during the abort of an LU command according to the second embodiment. For the sake of simplicity, FIG. 12 shows the first three queues in each of the command queue 74a and task queue 74b. In addition, for simplicity, suppose nothing has been queued in the command queue 74a and task queue 74b in the beginning.

As shown in FIG. 12, the host device 2 supplies a fourth command (ABORT: abort task) to the command analysis module 82 of the memory device 1. Then, the same operation as explained in the first embodiment (FIG. 11) is performed until the task (ABORT task) is queued in the task queue 74b.

As in the first embodiment, the task manager 72 performs setting so that the task queue 74b may be given priority over the command queue 74a. Therefore, the ABORT task is executed in preference to the WRITE(2) command. However, when the management module 81 has determined that the WRITE(2) command should not be aborted, the execution of the ABORT task causes only the READ command in the commands to be aborted in the command queue 74a and the WRITE(2) command not to be aborted. However, the management module 81 does not transmit, to the host device 2, a response reporting that the abort of the command has been completed before responses about commands not aborted (WRITE(1) and WRITE(2) commands) are transmitted to the host device 2.

Then, when the WRITE(1) command has been completed, the management module 81 transmits, to the host device 2, a response (RESPONSE (WRITE(1) command)) reporting the completion of the WRITE(1) command.

Then, the WRITE(2) command stored at the head is dequeued, thereby performing a write operation in the memory area 73. The command queue 74a has become empty again. The write operation is performed in the same manner as explained in the first embodiment.

Then, when the WRITE(2) command has been completed, the management module 81 transmits, to the host device 2, a response (RESPONSE (WRITE(2) command)) reporting the completion of the WRITE(2) command.

After the interruptible command has been aborted and responses about the commands not aborted have been issued to the host device 2, the management module 81 transmits, to the host device 2, a response (RESPONSE (ABORT task)) to the effect that all command aborts have been completed.

<Operational Advantages of the Memory Device According to the Second Embodiment>

With the second embodiment, the controller 71 distinguishes between one to be aborted and one not to be aborted of the first commands to be aborted.

Even when there is an LU command determined by the management module 81 not to be aborted in the LU commands to be aborted in the command queue 74a, a response about a command not to be aborted is transmitted to the host device 2 and then a response reporting the completion of the abort of the command is transmitted to the host device 2, thereby producing the same effect as that of the first embodiment.

<Modification and Others>

In the explanation, a command in the queue area 74 has been aborted by using a task (ABORT task). The method of aborting a command is not limited to this. Even when the queue area 74 is initialized by a specific command, a response about a command that could not be aborted is transmitted to the host device 2 and then the management module 81 transmits, to the host device 2, a response reporting the completion of the command, thereby producing the same effects as those of the first and second embodiments. In this case, the task manager 72 has performed setting so that the execution of the command is given priority over the command queue 74a. As described above, the first and second embodiments are not limited to the aforementioned command (ABORT task) and may be applied to any command, provided that it is a command to abort a command in the memory device 1.

While in the first and second embodiments, a UFS memory device has been used, any type of memory device may be used, provided that, for example, it is a memory system based on a client-server model.

In addition, while in the first and second embodiments, a UFS memory device has been used, another type of memory card, memory device, or internal memory may be used, provided that it is composed of a semiconductor memory device that operates in the same manner. In this case, too, the same operational advantages as those of the first and second embodiments are provided. In addition, the memory 11 is not limited to a NAND flash memory and may be another type of semiconductor memory.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory device comprising:
a nonvolatile memory;
a command storage module in which a command is stored; and
a controller which receives the command from a host device, stores the command in the command storage module, executes the command stored in the command storage module, and after having completed the execution of the command, transmits, to the host device, a first signal reporting the completion of the execution of the command,
wherein the command includes at least either a first command or a second command,
the controller causes the memory to be written to, read from, or erased from in response to the first command,
aborts the first command in the command storage module or the first command being executed in response to the second command,
aborts an interruptible one of the first commands to be aborted on having executed the second command, and
transmits the first signal about the second command after having transmitted the first signal about all the ones not aborted of the first commands to be aborted.

2. The memory device of claim 1, wherein the controller distinguishes between one to be aborted and one not to be aborted of the first commands to be aborted.

3. The memory device of claim 2, wherein the first command not to be aborted is the first command not aborted.

4. The memory device of claim 1, wherein the first commands to be aborted are plural.

5. The memory device of claim 1, further comprising an order controller which determines the order in which the first command and the second command are executed,
wherein the order controller executes the second command earlier than the first command.

6. The memory device of claim 1, wherein the command storage module includes a first command storage module and a second command module, and
the controller stores the first command in the first command storage module and the second command in the second command storage module.

7. The memory device of claim 1, wherein the command storage module is a matrix space, and
the commands are stored in the matrix space sequentially, starting from the head of the space, and the commands stored in the matrix space are executed sequentially, starting with the one at the head of the space.

8. A method of controlling a memory device, comprising:
receiving a command including at least either a first command or a second command from a host device;
storing the command in a command storage module;
executing the command stored in the command storage module;
causing a memory to be written to, read from, or erased from in response to the first command;
aborting the first command in the command storage module or the first command being executed in response to the second command;
aborting an interruptible one of the first commands to be aborted on having executed the second command;
transmitting, to the host device, a first signal reporting the completion of the execution of the command after having completed the execution of the command; and
transmitting the first signal about the second command after having transmitted the first signal about all the ones not aborted of the first commands to be aborted.

9. The method of claim 8, further comprising: distinguishing between one to be aborted and one not to be aborted of the first commands to be aborted.

10. The method of claim 9, wherein the first command not to be aborted is the first command not aborted.

11. The method of claim 8, wherein the first commands to be aborted are plural.

12. The method of claim 8, further comprising: executing the second command earlier than the first command.

13. The method of claim 8, wherein the command storage module includes a first command storage module and a second command module, and
the method further comprises storing the first command in the first command storage module and the second command in the second command storage module.

14. The method of claim 8, wherein the command storage module is a matrix space, and
the method further comprises storing the commands in the matrix space sequentially, starting from the head of the space, and executing the commands stored in the matrix space sequentially, starting with the one at the head of the space.
